(19) United States
(12) Patent Application Publication
(10) Pub. No.: US 2006/0093548 A1
(43) Pub. Date: May 4, 2006

(54) Using an air jacket to capture the heat of reaction for waste heat recycle in the production of aluminum fluoride

(75) Inventor: Dennis J. Eisele, Victoria, TX (US)

Correspondence Address: ECKERT SEAMANS CHERIN & MELLOTT, LLC;ALCOA TECHNICAL CENTER, 100 TECHNICAL DRIVE, ALCOA CENTER, PA, 15069-0001, US

(73) Assignee: Alcoa World Alumina LLC

(21) Appl. No.: 10/981,323

(22) Filed: Nov. 3, 2004

(51) Int. Cl. C01F 7/50

(52) U.S. Cl. 423/495

(57) ABSTRACT

A method to produce AlF₃ (20) from countercurrent contact of HF gas (18) and Al₂O₃.3H₂O (16) solids in a reactor (9) generates reaction heat in the reactor, and where air (42) is used as a coolant in a cooling jacket (44) around the outside of the reactor to produce heated air (46), which heated air is combusted with natural gas (52) to provide combusted exhaust gas (58) which can be used as a heating agent.

### FIELD OF THE INVENTION

The present invention relates to recycling the excess heat of reaction when producing aluminum fluoride from hydrogen fluoride gas and aluminum oxide preferably as Al₂O₃.3H₂O (gibbsite or alumina trihydrate or aluminum tri hydroxide).

### BACKGROUND OF THE INVENTION

The Hall-Heroult process was first used commercially around 1900. In this process, aluminum is extracted by electrolyzing aluminum oxide (also known as “alumina”) dissolved in a molten salt bath based on cryolite, Na₃AlF₆. The molten cryolite is operated at a temperature generally with the range of 950° C.-1000° C.

In U.S. Pat. No. 5,279,715 (LaCamera et al.) tried to lower the cryolite operating temperature to between 685° C.-900° C., by utilizing a bath comprising 36 wt % NaF and 64 wt % AlF₃. With widespread use of aluminum, materials such as AlF₃, used to make aluminum are in demand.

British Patent Specification No. 1,026,131 (Pegler) teaches producing aluminum fluoride (AlF₃) of high purity in a two stage process in which hydrated alumina (containing H₂O) is treated at a temperature below 550° C. with an excess of anhydrous (without H₂O) hydrogen fluoride followed by treating the product at a temperature of at least 650° C. with excess anhydrous hydrogen fluoride over that required to react stoichiometrically with any unreacted Al₂O₃.

In one process to make AlF₃, fluorspar (CaF₂) is reacted with sulfuric acid (H₂SO₄) in a kiln, where HF gas product passes into a reactor to contact alumina trihydrate (Al₂O₃.3H₂O). A description of this process is found in U.S. Pat. No. 6,517,790 B1 (Eisele). This reaction releases heat. In one instance, to cool the reactor, water is passed through Inconel tubes within the reactor. These tubes could develop cracks or the like, through which water or steam could pass to stop the reaction in the reactor. The tubes could also warp when the temperature reaches about 550° C. The water would quickly change phase to vapor with an attendant and large volume expansion, where the pressure gradient could rupture the tubes. Temperature control was also difficult because a small amount of water would produce very large temperature changes.

What is needed is an improved means to cool the countercurrent reactor. It is a main object of this invention to provide improved cooling of the reactor.

### SUMMARY OF THE INVENTION

The above problems are solved and needs are met by providing a method of producing aluminum fluoride in a reactor vessel by countercurrent contact of HF gas with Al₂O₃.3H₂O comprising the steps: reacting fluorspar and a strong containing sulfuric acid in a heated kiln to produce HF gas; feeding the HF gas to a reactor having at least two stages, where Al₂O₃.3H₂O is also feed into the reactor to countercurrent contact the HF gas to produce heat and AlF₃; passing pressurized cool air into an external cooling jacket surrounding the outside of at least one of the stages of the reactor to remove excess heat of reaction and provide heated air at a temperature of about 210° C. (410° F.) to about 410° C. (770° F.); circulating the heated air into a combustion furnace to react with natural gas providing combusted exhaust gas; and passing the combusted exhaust gas into a jacket surrounding the heated kiln of step (1), to heat the kiln.

Preferably the pressurized cool air flows into the cooling jacket at the rate of about 400 cu ft/min (11.3 cu meters/min) to about 700 cu ft/min (19.8 cu meters/min) and the heated air discharge is from about 260° C. (500° F.) to about 360° C. (680° F.) so that the cooling jacket temperature is substantially less than the usual 550° C. (1020° F.) temperature to which Inconel tubes had been subjected in one prior art embodiment of the invention. This provides improved cooling of the reactor.

Preferably the reactor contains three stages with the cooling jacket being disposed about the outer circumference of the second (middle) stage of the reactor. The kiln in previous processes had been heated by combusting natural gas. By use of heated air, from about 300,000 BTU/hr to about 375/000 BTU/hr energy from natural gas is displaced, providing efficient, less costly kiln heating, and allowing recycle of the excess heat of reaction from the countercurrent reactor.

One advantage of the new process is the recycling of waste heat from one part of the process and using it another. The other advantage is eliminating the internal cooling tubes that used water and were prone to failure and caused excessive down time. And finally, feedback temperature control is much easier with the air as opposed to the water.

### BRIEF DESCRIPTION OF THE DRAWINGS

A full understanding of the invention can be appreciated from the following detailed description of the invention when read with reference to the accompanying drawings wherein:

FIG. 1 is a schematic block diagram of one prior art method of producing AlF₃ in a reactor utilizing interior Inconel tubes carrying water for cooling the reactor; and

FIG. 2 is a schematic block diagram showing one embodiment of this invention using a circumferential exterior of the reactor, using air is a coolant, which air can then be recycled to combine with natural gas to heat other parts of the system.

### DETAILED DESCRIPTION OF PREFERRED EMBODIMENTS

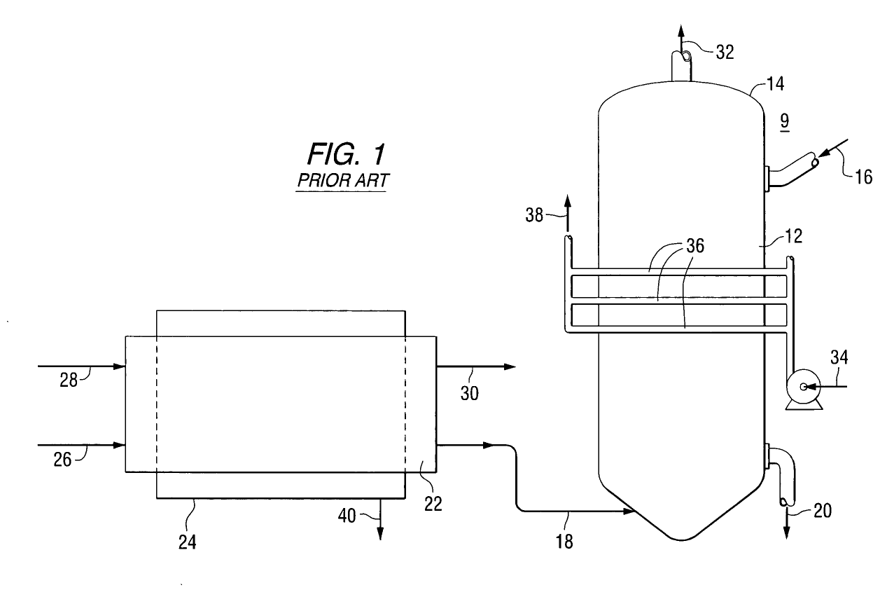

The reaction for hydrogen fluoride gas and alumina trihydrate solids is given below: 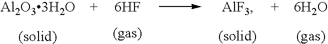
with literature values of released heat of reaction reported to be between 126 to 133 kJ/mol Alf₃. This reaction is exothermic and so generates substantial heat which requires cooling control. One prior art system to produce aluminum fluoride is shown in FIG. 1. To produce HF gas, fluorspar (CaF) 26 is reacted with a strong sulfuric acid (H₂SO₄) or a mixture of strong sulfuric acid and oleum (fuming sulfuric acid-pyrosulfuric acid) 28 in a heated kiln 22 at a temperature of between about 176.7° C. (350° F.) to about 232.2° C. (450° F.) to produce calcium sulfate (CaSO₄) solids 30 and HF gas 18. Hydrochloric, nitric, or phosphoric acid will not work in this step. The kiln can have a kiln jacket 24 surrounding it where natural gas, or like heating medium can be combusted. The hot HF gas 18 is passed to a reactor 9 to react with alumina trihydrate (Al₂O₃.3H₂O) 16 as shown. Due to the exothermic nature of the reaction, it is necessary to cool the reactor, especially in the center where temperatures can reach about 550° C. (1022° F.). Coolant water 34 can be pumped through Inconel tubes 36 which pass through the center of the reactor 9 and in which steam 38 is generated. Additionally, AlF₃ product 20 is removed and water vapor exhaust 32 is released.

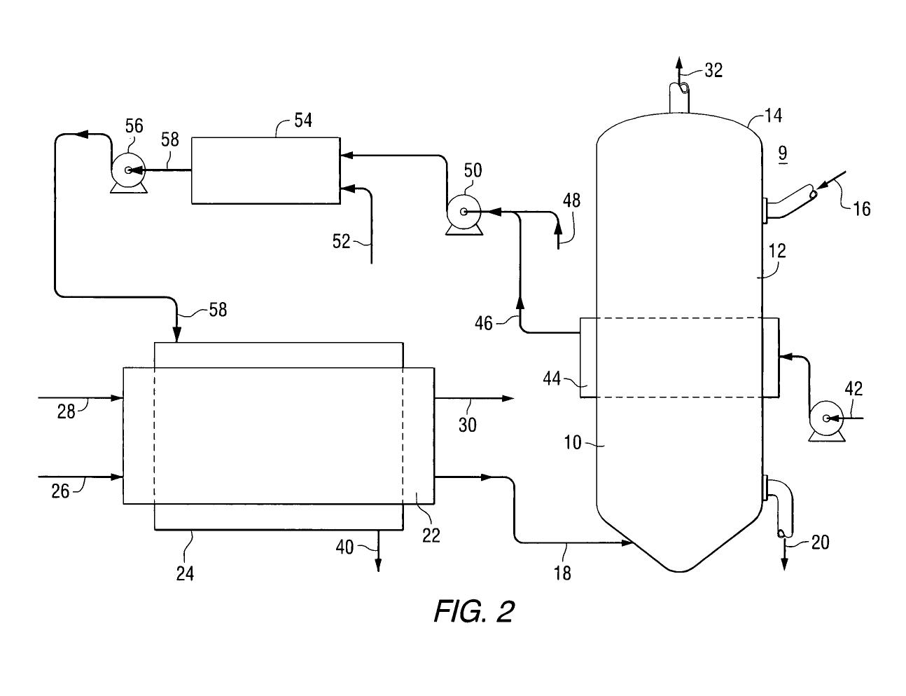

FIG. 2 shows a new system that utilizes ambient air 42 as a coolant, passing it through an exterior reactor jacket 44 to provide hot air 46 which is further reacted to heat the kiln 22 that produces HF gas 18. The reactor 9 is a countercurrent reactor of multiple stages or beds, for example 10, 12 and 14 where Al₂O₃.3H₂O solids are fed into the top at stage 14 and HF gas is fed into the bottom at stage 10 with gas flowing upward and solids passing downward, providing heat and AlF₃ solid product 20. Al₂O₃.3H₂O is the preferred feedstock solids providing excellent yield of AlF₃ at controllable temperatures. Use of Al₂O₃.H₂O would double the heat reaction, and use of anhydrous alumina (Al₂O₃) would triple the heat and require sophisticated and expensive cooling as well as materials problems for the reactor 9. Even using Al₂O₃.3H₂O, some Al₂O₃.H₂O will be formed in the top of the reactor at stage or bed 3.

Preferably the feedstock Al₂O₃.3H₂O 16 is heated up to about 55° C. (131° F.) to about 65° C. (149° F.) to ensure quick reaction in the reactor 9 and the HF gas is supplied from the kiln 22 to the bottom of the reactor at from about 75° C. (167° F.) to about 85° C. (185° F.). The hot air 46 exits the reactor at between about 210° F. (410° F.) to about 410° C. (770° F).

Air 42 is used as the cooling medium on the outside cooling jacket 44. The air flow to the cooling jacket can be about 500 to 600 cubic feet per minute based on a cooling jacket per surface area of 60 square feet and a cylindrical reaction vessel of from 6.5 to 7.0 feet in diameter. The discharge temperature of the heated air 46 is preferably from 260° C. (500° F.) to 360° C. (680° F.) with automatic feedback temperature control. The hot air that is discharged from the jacket can then be reused in another part of the aluminum fluoride process, namely to supply heat to the kiln 22 that produces the hydrogen fluoride gas 18.

The first part of the aluminum fluoride process involves producing hydrogen fluoride gas. The hydrogen fluoride gas is produced in a kiln by the reaction between sulfuric acid or sulfuric acid plus fuming sulfuric acid and fluorspar (calcium fluoride). This is an endothermic reaction and requires heat. The heat is usually supplied by burning natural gas in a furnace and circulating the hot combustion gases around the outside of the kiln in a heating jacket. In this invention, the heated/hot air 46 from the outside cooling jacket is brought back to a combustion air blower 50, that then passes combustion air to burn with natural gas 52, in a furnance 54 that supplies heat to the kiln 22. The hot air from bed 12 of the fluidized bed reactor, when mixed with natural gas, displaces about 300,000 to 375,000 BTUs per hour that were previously supplied solely by natural gas for heating the kiln.

The results of this invention have shown that the published values in the literature for the heat of reaction of aluminum try-hydrate reacting with hydrogen fluoride gas are incorrect. The use of the air jacket has shown that the actual heat of reaction produces approximately −10,000 kJ/mol of AlF₃. In thermodynamics, the negative sign indicates that heat is given off.

Further elaborating on FIG. 2, as shown, the hot air 46 can be blended with outside ambient air 48 to arrive at desired temperature and then passed to a combustion air blower 50 and fed into combustion furnace along with natural gas 52. There, the two are combusted and passed, by combustion fan 56, as combustion mixture 58 to the kiln jacket 24 heat kiln 22. This allows substitution of substantial amounts of natural gas. Also shown are gypsum (CaSO₄) solids 30 and kiln jacket exhaust 40. The volume ratio of heated air 44 to outside air 46 can be from zero outside air to about 28:10 heated air:outside air. The volume ratio of total air from combustion air blower 50 to natural gas within the combustion furnace 54 is from about 120:10: to 160:10 air:natural gas.

While this invention and many of its attendant advantages will be understood from the foregoing description, and it will be apparent that various modifications and changes can be made in the process without departing from the spirit and scope of the invention.

What is claimed is:

1. A method of producing aluminium fluoride in a reactor vessel by countercurrent contact of HF gas with Al₂O₃.3H₂O comprising the steps:
(1). reacting fluorspar and a strong acid containing sulphuric acid in a heated kiln to produce HF gas;
(2). feeding, the HF gas to a reactor having at least two stages, where Al₂O₃.3H₂O is also feed into the reactor to countercurrent contact the HF gas to produce heat and AlF₃;
(3). passing pressurized cool air into an external cooling jacket surrounding the outside of at least one of the stages of the reactor to remove excess heat of reaction and provide heated air at a temperature of about 210° C. to about 410° C.;
(4). circulating the heated air into a combustion furnace to react with natural gas providing combusted exhaust gas; and
(5). passing the combusted exhaust gas to heat the kiln of step (1), wherein the use of the cooling jacket produces a heat of reaction of about −10.000 kJ/mol of AlF₃.

2. The method of claim 1, wherein the acid used in step (1) is selected from the group consisting of sulfuric acid and a mixture of sulfuric acid and fuming sulfuric acid.

3. The method of claim 1, wherein the heated air provided in step (3) has a temperature of about 260° C. to about 360° C., and the pressurized cool air passes into the cooling jacket at the rate of about 11.3 cu meters/min to about 19.8 cu meters/min.

4. The method of claim 1, wherein, in step (3) the cooling jacket temperature is less than 550° C.

5. The method of claim 1, wherein the temperature of the kiln in step (1) is from about 176.7° C. to about 232.2° C. and the CaSO₄ solids are also produced.

6. The method of claim 1, wherein the reactor has three stages and water vapour is released.

7. The method of claim 1, wherein the Al₂O₃.3H₂O is heated up to about 55° C. before being fed into the reactor and the HF gas is supplied from the kiln to the reactor at from about 75° C. to about 85° C.,

8. The method of claim 1, wherein the heated air in step (4) displaces about 300,000 to 375,000 BTU's per hour of natural gas passing to heat the kiln.

9. The method of claim 1, wherein, in step (3) outside air is added to heated air in a volume ratio of up to about 28:10 heated air:outside air.

10. The method of claim 1, wherein, in step (4) the volume radon of total air to natural gas is from about 120:10 to 160:10 air:natural gas.
